(19) United States
(12) Patent Application Publication
(10) Pub. No.: US 2025/0376004 A1
(43) Pub. Date: Dec. 11, 2025

(54) VEHICLE THERMAL MANAGEMENT SYSTEM

(71) Applicants: HYUNDAI MOTOR COMPANY, Seoul (KR); KIA CORPORATION, Seoul (KR)

(72) Inventors: Jae Woong Kim, Hwaseong-si (KR); Se Kyu Oh, Hwaseong-si (KR); Ki Hoon Kim, Hwaseong-si (KR); Dae Ki Hong, Hwaseong-si (KR); Seok Jin Hong, Hwaseong-si (KR)

(73) Assignees: HYUNDAI MOTOR COMPANY, Seoul (KR); KIA CORPORATION, Seoul (KR)

(21) Appl. No.: 18/961,039

(22) Filed: Nov. 26, 2024

(30) Foreign Application Priority Data
Jun. 7, 2024 (KR) 10-2024-0074519

(51) Int. Cl. B60H 1/00

(52) U.S. Cl. CPC B60H 1/00899

(57) ABSTRACT

A vehicle thermal management system includes: a fluid transfer device that is provided with a cooling or heating function for interior air conditioning of a vehicle and consumes electric power to perform the cooling or heating function; and a control unit that controls the fluid transfer device based on an optimal control value. In particular, proportions of air conditioning target tracking performance and energy consumption for the air conditioning target tracking reflected in the optimal control value vary depending on an input optimal control setting value.

### CROSS-REFERENCE TO THE RELATED APPLICATION

This application claims priority to Korean Patent Application No. 10-2024-0074519, filed on Jun. 7, 2024, the disclosure of which is incorporated herein by reference in its entirety.

### BACKGROUND

### 1. Field

The present disclosure relates to a vehicle thermal management system for performing thermal management of a vehicle.

### 2. Description of Related Art

Recently, due to growing interest in the environment, the number of eco-friendly vehicles equipped with an electric motor as a power source has been increasing. Such an eco-friendly vehicle is also called an electrified vehicle, which includes a hybrid electric vehicle (HEV) or an electric vehicle (EV) as a representative example. Since the electrified vehicle consumes electrical energy not only for driving, but also for indoor air conditioning, the efficiency of indoor air conditioning has a significant influence on the vehicle's fuel efficiency and overall energy efficiency including fuel efficiency.

In particular, among electrified vehicles, in the case of an electric vehicle that does not have an engine and runs only through driving force of a motor, energy efficiency is very important since it is impossible to recover waste heat from the engine for indoor air conditioning.

In addition, in the electrified vehicle, since the operating performance of parts such as high-voltage batteries and motors for driving is affected by temperature, it is desired to consider requirements for the parts as well as the indoor air conditioning in terms of thermal management.

Accordingly, in order to optimally perform vehicle thermal management to improve the energy efficiency of the vehicle, it is desired to generally take into account constraints on vehicle parts and indoor air conditioning targets.

The above information disclosed in this background section is only for understanding of the background of the present disclosure, and therefore, may not constitute prior art that is already known to those having ordinary skill in the art.

### SUMMARY

The present disclosure has been made in view of the above problems, and it is an object of the present disclosure to provide a vehicle thermal management system capable of variably performing optimal control for vehicle thermal management according to user's setting.

The above-mentioned object is not limiting, and not-mentioned other objects should be clearly understood by those having ordinary skill in the art from the description below.

In one embodiment of the present disclosure, the above object can be accomplished by a vehicle thermal management system that includes a fluid transfer device. The fluid transfer device is provided with a cooling or heating function for interior air conditioning of a vehicle with electric power to perform the cooling or heating function. The vehicle thermal management system further includes: a control unit that controls the fluid transfer device based on an optimal control value obtained by reflecting air conditioning target tracking performance and energy consumption for air conditioning target tracking, in which proportions of the air conditioning target tracking performance and the energy consumption for the air conditioning target tracking reflected in the optimal control value vary depending on an input optimal control setting value.

The optimal control setting value may include a first setting value for increasing the proportion of the air conditioning target tracking performance reflected in the optimal control value, and a second setting value for increasing the proportion of the energy consumption for the air conditioning target tracking reflected in the optimal control value.

The optimal control setting value may include a third setting value for balancing the proportion of the air conditioning target tracking performance reflected in the optimal control value and the proportion of the energy consumption for the air conditioning target tracking reflected in the optimal control value.

The control unit may control the fluid transfer device based on a preset optimal control mode, and the optimal control mode may include a first optimal control mode for controlling an air conditioning target arrival time on the basis of the derived optimal control value while maintaining an air conditioning target.

The control unit may control the fluid transfer device based on a preset optimal control mode, and the preset optimal control mode may include a second optimal control mode that controls an air conditioning target arrival time based on the derived optimal control value and adjusts the air conditioning target.

The control unit may adjust the air conditioning target based on the optimal control setting value in the second optimal control mode.

The control unit may change the air conditioning target when the input optimal control setting value is the second setting value, in the second optimal control mode.

The air conditioning target may include a target temperature of interior air of the vehicle.

The control unit may change the air conditioning target in further consideration of whether the interior air conditioning is cooling or heating, in the second optimal control mode.

The control unit may increase the target temperature of the interior air when the input optimal control setting value is the second setting value and the interior air conditioning is cooling, in the second optimal control mode.

The control unit may decrease the target temperature of the interior air when the input optimal control setting value is the second setting value and the interior air conditioning is heating, in the second optimal control mode.

The air conditioning target may include a target flow rate of air discharged into a cabin of the vehicle.

The control unit may decrease the target flow rate of air discharged into the cabin when the input optimal control setting value is the second setting value, in the second optimal control mode.

The control unit may change the air conditioning target in further consideration of upper and lower limits of the preset air conditioning target.

The control unit may maintain the air conditioning target when the input optimal control setting value is the first setting value, in the second optimal control mode.

The control unit may determine a control value for minimizing a cost function for a preset prediction range as the optimal control value, and the cost function may reflect a state cost having a first weight for the air conditioning target tracking performance and a control input cost having a second weight for the energy consumption for the air conditioning target tracking.

The first weight and the second weight may vary according to the optimal control setting value, and as the first weight increases, the proportion of the air conditioning target tracking performance reflected in the optimal control value may increase, and as the second weight increases, the proportion of the air conditioning target tracking reflected in the optimal control value may increase.

The control unit may derive the optimal control value using a control model for a predictive state value according to a current state value.

The control unit may store the optimal control setting value and derive the optimal control value according to the stored optimal control setting value.

The vehicle thermal management system may further include an interface unit that receives the optimal control setting value from a user, and transmits the received optimal control setting value to the control unit.

### BRIEF DESCRIPTION OF THE DRAWINGS

The above and other objects, features and other advantages of the present disclosure should be more clearly understood from the following detailed description taken in conjunction with the accompanying drawings, in which:

FIG. 1 is a diagram showing a configuration of a fluid transfer device of a thermal management system that is applicable to embodiments of the present disclosure;

FIG. 2 is a diagram showing a configuration of a vehicle thermal management system according to an embodiment of the present disclosure;

FIG. 3 is a diagram for illustrating an optimal control process of a control unit according to an embodiment of the present disclosure;

FIGS. 4A to 4C are diagrams for illustrating optimal control according to air conditioning setting values according to an embodiment of the present disclosure;

FIGS. 5A and 5B are diagrams for illustrating an example of air conditioning target adjustment according to an embodiment of the present disclosure;

FIG. 6 is a diagram showing an example of implementation of an interface unit according to an embodiment of the present disclosure; and

FIG. 7 is a flowchart for illustrating a process of performing vehicle thermal management according to an embodiment of the present disclosure.

### DETAILED DESCRIPTION

The following specific structural and functional descriptions of embodiments of the present disclosure are merely illustrative for the purpose of describing the embodiments according to the present disclosure, and the embodiments according to the present disclosure may be implemented in other various forms.

Reference is made in detail to various embodiments of the present disclosure, examples of which are illustrated in the accompanying drawings and described below. The present description is not intended to limit the disclosure to the embodiments, and various alternatives, modifications, equivalents and other embodiments should be interpreted as being within the spirit and scope of the present disclosure.

Unless clearly defined otherwise, terms used herein, including technical or scientific terms have the same meaning as understood by those having ordinary skill in the art. Terms defined in commonly used dictionaries should be interpreted as having meanings consistent with meanings in the context of the related technology, and unless clearly defined in this specification, should not be interpreted as having ideal or excessively formal meanings.

Hereinafter, reference is made in detail to various embodiments of the present disclosure, examples of which are illustrated in the accompanying drawings. Wherever possible, the same reference numbers are used throughout the drawings to refer to the same or like parts.

In the description of the following embodiments, the term “preset” or “predetermined” means that, in a case where a parameter is used in a process or algorithm, a value of the parameter is set or determined in advance. Depending on the embodiments, the value of the parameter may be set when the process or algorithm starts, or may be set during a section in which the process or algorithm is performed.

The suffixes “module” and “unit” for components used in the following description are given or used interchangeably only for ease of description of the specification, and do not have distinct meanings or roles in themselves.

In describing the embodiments, detailed descriptions of related known technologies have been omitted as necessary. It should be understood that the accompanying drawings are given hereinafter by way of illustration only and are not limitative of the present disclosure, and the present disclosure is intended to cover various alternatives, modifications, equivalents and other embodiments, within the spirit and scope of the disclosure as defined by the appended claims.

It should be understood that, although the terms “first”, “second”, etc. may be used herein to describe various elements, these elements should not be limited by these terms. These terms are only used to distinguish one element from another.

In addition, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween.

As used herein, the singular forms “a”, “an”, and “the” are intended to include the plural forms as well, unless the context clearly indicates otherwise.

It should be further understood that the terms “comprise”, “include”, and “have” used herein merely specify the presence of stated features, numbers, steps, operations, components, parts, or combinations thereof, but do not preclude the presence or addition of one or more other features, numbers, steps, operations, components, parts, or combinations thereof.

In addition, a “unit” or a “control unit” included in names of a motor control unit (MCU), a hybrid control unit (HCU), and the like merely refers to a controller that controls specific vehicle functions, and does not refer to a generic functional unit.

When a component, device, element, or the like of the present disclosure is described as having a purpose or performing an operation, function, or the like, the component, device, or element should be considered herein as being “configured to” meet that purpose or to perform that operation or function.

The controller may include a communication device that communicates with other controllers or sensors to control a specific function, a memory that stores an operating system, logic commands, input/output information, etc., and one or more processors that perform determinations, calculations, and decision-making necessary to control corresponding functions.

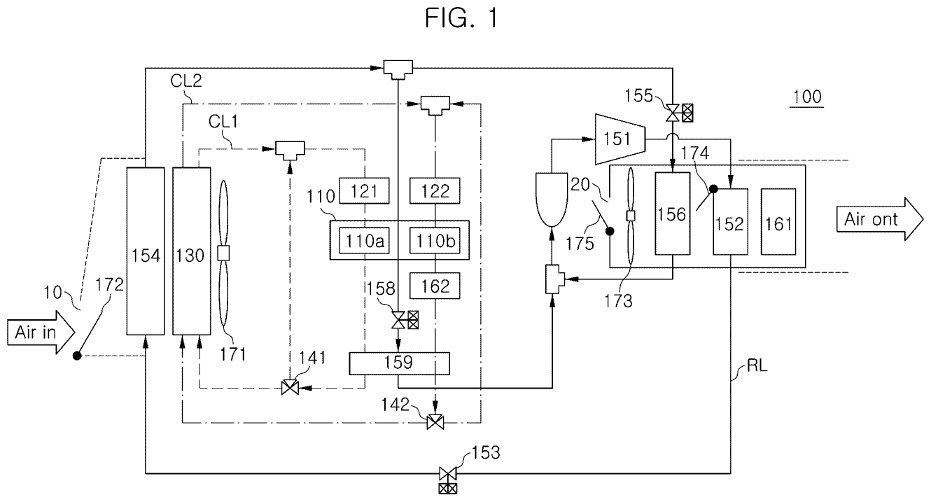

Hereinafter, before describing an operation of a control unit for performing vehicle thermal management according to an embodiment of the present disclosure, an example of implementation of a fluid transfer device applicable to the embodiments of the present disclosure is described with reference to FIG. 1.

FIG. 1 is a diagram illustrating a configuration of a fluid transfer device of a thermal management system that is applicable to embodiments of the present disclosure.

Referring to FIG. 1, a fluid transfer device 100 that is applicable to embodiments of the present disclosure may perform vehicle thermal management such as cooling or heating of at least one vehicle's part 110 or air conditioning of a vehicle's cabin.

To this end, the fluid transfer device 100 may be provided with coolant lines (CL1, CL2) for heat exchange with the vehicle's part 110, and a refrigerant line (RL) for heat exchange with a coolant and surrounding air.

More specifically, the plurality of coolant lines (CL1, CL2) provided in the fluid transfer device 100 are individually used for heat exchange with each vehicle's part 110 for thermal management of the vehicle parts 110 that are different from each other.

Here, the vehicle parts 110 may include a drive system 110a including a motor and an inverter, and a battery 110b. However, in the embodiments of the present disclosure, the vehicle parts 110 are not necessarily limited to the above examples, and may include various parts that require heat dissipation. For example, the vehicle parts 110 according to embodiments of the present disclosure may include various types of controllers (not shown), such as an autonomous drive control unit, a motor control unit, a vehicle control unit, and a control unit for integrated thermal management.

While the coolant line (CL1) for thermal management of the drive system 110a and the coolant line (CL2) for thermal management of the battery 110b are shown in FIG. 1, in the implementation of the fluid transfer device 100, such the coolant lines (CL1, CL2) may be replaced with coolant lines for thermal management of other vehicle parts 110, such as controllers, or may coexist with coolant lines for the thermal management of other vehicle parts 110. Further, as an implementation example of the fluid transfer device 100, there may be various cases, such as a case where only a single coolant line is provided for the thermal management of one vehicle part 110, or a case where plural vehicle parts 110 are connected in series to a single coolant line.

Pumps 121 and 122 may be respectively provided in the coolant lines (CL1, CL2) for coolant circulation, and may consume power to flow a coolant toward the vehicle part 110. The pumps 121 and 122 may be, for example, electric water pumps (EWP) that circulate a coolant by operating a motor with electrical energy.

The coolant flowing into the vehicle part 110 through the pumps 121 and 122 may absorb heat generated from the vehicle part 110 through heat exchange while passing through the vehicle part 110, thereby cooling the vehicle part 110.

The coolant having passed through the vehicle part 110 flows toward a radiator 130, where it releases the heat absorbed from the vehicle part 110 to the surroundings while passing through the radiator 130. It then flows back into the vehicle part 110.

Here, the radiator 130 may be provided individually for each of the coolant lines (CL1, CL2), and in this case, the radiators 130 corresponding to the respective coolant lines (CL1, CL2) may include, for example, a high-temperature radiator and a low-temperature radiator.

The refrigerant line (RL) is connected to a compressor 151, a plurality of condensers 152 and 154, a plurality of expanders 153, 155, and 158, an evaporator 156, an accumulator 157, and a heat absorber 159. The fluid transfer device 100 may perform cooling or heating through these components.

Here, the compressor 151 may discharge a refrigerant at high temperature and high pressure by consuming power for the cooling or heating function through refrigerant circulation. The refrigerant passed through the compressor 151 passes through the indoor condenser 152, the expander 153, the outdoor condenser 154, the expander 155, the evaporator 156, and the accumulator 157 to repeat heat dissipation and heat absorption to/from the surroundings.

In particular, the refrigerant line (RL) may pass through the coolant lines (CL1, CL2) to recover waste heat of the vehicle part 110 from the coolant lines (CL1, CL2), and may perform heat exchange with the coolant lines (CL1, CL2) through the heat absorber 159 connected to the coolant lines (CL1, CL2). The fluid transfer device 100 may be provided with a plurality of the heat absorbers 159, instead of the configuration shown in FIG. 1, and in this case, the plurality of heat absorbers 159 may be connected to the different coolant lines (CL1, CL2).

In order to perform vehicle thermal management for different purposes, the fluid transfer device 100 may form various heat transfer paths through the coolant lines (CL1, CL2).

For example, the coolant line CL1 for thermal management of the drive system 110a may form a heat transfer path that discharges heat absorbed from the drive system 110a to the outside through the radiator 130 and a heat transfer path that transfers heat absorbed from the drive system 110a to the refrigerant line (RL) through the heat absorber 159. In this case, these heat transfer paths may be formed simultaneously.

The above-mentioned heat transfer paths may vary depending on a coolant flow direction, and the coolant flow direction may be adjusted by a valve 141 provided in the coolant line CL1, for example. Further, the coolant circulation may be suppressed by stopping the operation of the pump 121 so that the heat generated in the drive system 110a does not escape through the radiator 130 or the heat absorber 159.

As another example, the coolant line CL2 for thermal management of the battery 110b may form a heat transfer path that discharges heat absorbed from the battery 110b to the outside through the radiator 130 and a heat transfer path that does not pass through the radiator 130. In particular, in the heat transfer path that does not pass through the radiator 130, according to the refrigerant circulation in the refrigerant line RL, the heat generated in the battery 110b may be transferred to the refrigerant line RL through the heat absorber 159 to cool the battery 110b, or the heat of the coolant heated through the heater 162 that heats the coolant may be transferred to the battery 110b, instead of being transferred to the coolant line RL, to increase the temperature of the battery 110b. The above-mentioned heat transfer paths may vary depending on the coolant flow direction, and the coolant flow direction may be adjusted by a valve 142 provided in the coolant line CL2.

The fluid transfer device 100 recovers the heat (i.e., waste heat) generated from the vehicle part 110 through the heat transfer path for transferring the heat absorbed from the vehicle part 110 to the refrigerant line RL through the heat absorber 159, among the above-mentioned heat transfer paths, for indoor thermal management, or the like, thereby improving the energy efficiency of the vehicle thermal management.

The fluid transfer device 100 may also exchange heat with external air and may use heat absorbed through the heat exchange with the external air for the thermal management. More specifically, the heat exchange with the external air may be performed indirectly through the radiator 130 or may be performed through an external evaporator (not shown) that absorbs heat from external air.

In performing such thermal management, the fluid transfer device 100 may control air flow from outdoors to indoors, and may be equipped with a blower, an opening/closing device, or the like to control the air flow.

The blower may include, for example, a cooling fan 171 for controlling inflow of external air and a blower 173 for controlling discharge of air into the vehicle's cabin. The opening/closing device may include, for example, an air flap 172 for controlling inflow of external air and a temp door 174 for controlling discharge of air into the cabin. The above-mentioned blower and opening/closing device may consume power to perform operations thereof.

In addition, the fluid transfer device 100 may include a heat transfer device for increasing the temperature of air or the coolant. The heat transfer device may include a heater 161 for heating air discharged into the cabin. In this case, the heater 161 may be, for example, a positive temperature coefficient (PTC) heater. Further, as described above, the heat transfer device may include a heater 162 for heating the coolant to increase the temperature of the battery 110b.

According to the structure of the fluid transfer device 100 as described above, the thermal management of the vehicle may be performed in various ways. In particular, various thermal management scenarios may be derived depending on an interior condition of the vehicle, an external condition of the vehicle, conditions of the vehicle parts 110a and 110b, and the like.

FIG. 1 mainly shows components related to the description of the fluid transfer device.

100, which is applicable to the embodiments of the present disclosure. However, in practice, the fluid transfer device 100 may include more or fewer components than the shown components.

In addition, the fluid transfer device 100 described with reference to FIG. 1 merely represents an example implementation applicable to the embodiments of the present disclosure and is not intended to be limiting.

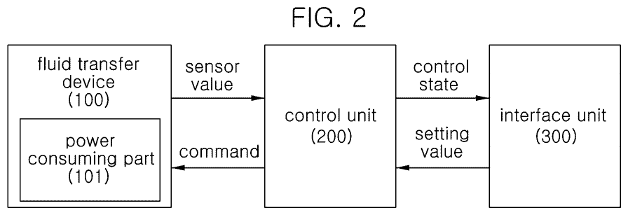

FIG. 2 is a diagram showing a configuration of a vehicle thermal management system according to an embodiment of the present disclosure.

Referring to FIG. 2, a vehicle thermal management system according to an embodiment of the present disclosure may include the fluid transfer device 100, a control unit 200, and an interface unit 300. Here, FIG. 2 mainly shows components related to the description of the embodiment of the present disclosure. However, in practice, the vehicle thermal management system may include more or fewer components.

The fluid transfer device 100 may be implemented as described in the example with reference to FIG. 1, and the control unit 200 may include an algorithm for performing a vehicle thermal management function, a memory configured to store data and software instructions for executing such an algorithm, a processor configured to perform operations to be described below using the data and/or software stored in the memory, a controller therefor, and the like.

The control unit 200 may be implemented as a single integrated controller, or as a function within a specific controller provided in the vehicle. Further, the control unit 200 may be implemented as a combination of a plurality of controllers, for example, a combination of a higher-level controller that performs determinations or calculations necessary for vehicle thermal management to generate control commands, and a lower-level controller that receives the control commands from the higher-level controller to respectively control the components of the fluid transfer device 100.

The interface unit 300 may receive setting values from a vehicle user (e.g., a driver) to transmit the setting values to the control unit 200, and may receive information on control states from the control unit 200 and output the information in visual or auditory formats. To this end, the interface unit 300 may be implemented as a vehicle cluster or an AVNT (Audio, Video, Navigation, Telematics) device, or as a terminal of the vehicle user.

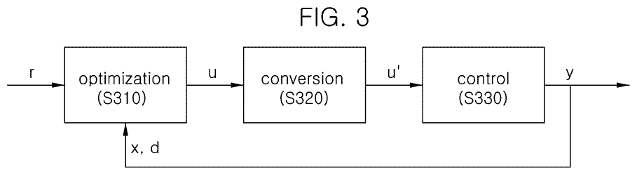

The control unit 200 may perform optimal control for vehicle thermal management, which is described with reference to FIG. 3.

FIG. 3 is a diagram for illustrating an optimal control process of a control unit according to an embodiment of the present disclosure.

Referring to FIG. 3, the control unit 200 according to the present embodiment may perform vehicle thermal management through processes of optimization (an operation S310), conversion (an operation S320), and control (an operation S330).

In one embodiment, the optimization process (the operation S310) may be performed on a model basis. For example, PID (Proportional, Integral, Differential) control or LOR (Linear Quadratic Regulator) control may be used for the optimization. In particular, the optimization (S310) according to the present embodiment may be performed through MPC (Model-based Predictive Control).

More specifically, the optimization process (S310) through the model-based predicative control may be basically performed to reduce future errors in deriving an optimal control value (u) for allowing an output value (y) to follow a target value (r).

To this end, the optimal control value (u) may be derived using a control model for a predictive state value according to a current state value (x). In other words, the optimal control value (u) may be derived by considering not only a current state but also a predicted future state.

In the control model for the predictive state value, the current control value (u), and at least one disturbance (d) in addition to the current state value (x) may be further reflected, which may be expressed as follows.

xₖ₊₁=Aₖxₖ+Bₖuₖ+B_{w,k}wₖ+B_{ϕ,k}

In the above equation, xₖ and xₖ₊₁ represent a current state value and a predictive state value, and wₖ represents disturbance. Aₖ, Bₖ, and B_{w,k} represent influences of a current state, a control input, and the disturbance on a future state, respectively, and B_{ϕ,k} is a term for reflecting the uncertainty of prediction.

By utilizing such a control model for the predictive state value, it is possible to reflect the predicted future state in deriving the optimal control value.

In the optimization process (S310), prior to deriving the optimal control value (u), optimization for the target value (r) may also be performed. In this case, the optimization for the target value (r) may be performed in a normal state, and the control model for the output value may be utilized here. Here, the control model for the output value represents the current state value and the output value according to the current control value, which may be expressed as follows, for example.

$$[ \begin{matrix}{A}_{K} - 1 & {B}_{K} \\ {C}_{k} & 0\end{matrix} ] [ \begin{matrix}{x}_{ss} \\ {u}_{ss}\end{matrix} ] [ \begin{matrix}- ( {B}_{w , k} {w}_{k} + {B}_{∅ , k} ) \\ r\end{matrix} ]$$

Here, xₛₛ and uₛₛ mean a state value and a control value in a normal state, and wₖ means disturbance. Aₖ, Bₖ, and B_{w,k} represent influences of a current state, a control input, and disturbance on a future state, respectively, Ck represents an influence of a state value on an output value, and r represents a target value (i.e., the output value that is a control target). B_{ϕ,k} is a term for reflecting the uncertainty of prediction.

In the optimization process (S310) through the model-based predictive control, the optimal control value (u) may be derived through a cost function for a preset prediction range.

Here, the preset prediction range represents how far the future prediction is to be performed, which may be expressed as a prediction horizon. As the prediction range increases, the optimization performance may be improved. However, as the prediction range increases, the computational load of the control unit 200 for prediction may increase.

In one embodiment, the optimal control value may be determined as a control value for minimizing the cost function for the preset prediction range. In this case, a state cost with a weight for the state value and a control input cost with a weight for the control value may be reflected in the cost function. Further, a final state cost with a weight for a final state value of the prediction range and a control change cost with a weight for the amount of change in the control value may be further reflected. For example, the cost function may be expressed as follows.

$$J ( {U}_{k} ) = {x}_{N}^{T} {Q}_{f} {x}_{N} + {\sum }_{i = 0}^{N - 1} ( {‖ {x}_{k + i} - {x}_{ss , k} ‖}_{Q}^{2} + {‖ {u}_{k + i} - {u}_{ss , k} ‖}_{R}^{2} + {‖ Δ {u}_{k + i} ‖}_{{R}_{du}}^{2} )$$

Here, J(Uₖ) is a cost function, and an optimal control value may be determined as a control value corresponding to a current point among control values (Uₖ) for minimizing J(Uₖ). xₖ₊ᵢ and x_{ss,k} correspond to a predictive state value for a prediction range and a target state value for outputting a target value (r), respectively.

In the control process through the optimal control value (u), xₖ₊ᵢ changes to follow x_{ss,k}. Here,

$${‖ {x}_{k + i} - {x}_{ss , k} ‖}_{Q}^{2}$$

is a term for reflecting the cost for a state value, which is related to a speed at which the predictive state value reaches the target state value. As a weight Q becomes larger, the speed at which the predictive state value reaches the target state value becomes faster. In other words, as the weight Q becomes larger, the control target tracking performance becomes better, thereby making it possible to quickly achieve the control target.

uₖ₊ᵢ and u_{ss,k} represent a predictive control value for a prediction range and a target control value for outputting the target value (r), respectively. In the control process through the optimal control value (u), uₖ₊ᵢ changes to follow is a term for reflecting the cost of u_{ss,k}. Here,

$${‖ {u}_{k + i} - {u}_{ss , k} ‖}_{R}^{2}$$

is a term for reflecting the cost of a control value and is related to a speed at which the predictive control value reaches the target control value. As a weight R becomes larger, energy consumed for the predictive state value to reach the target state value decreases. In other words, as the weight R becomes larger, the control energy performance becomes better, thereby making it possible to achieve the control target less energy.

Further, x_{N} represents a final state value of a preset prediction range, and Q_{f} represents a weight for the final state value. Here,

$${x}_{N}^{T} {Q}_{{f}^{x} N}$$

is a term for reflecting the cost of a final state, which may be applied to ensure the stability of prediction through a finite prediction range.

$${‖ Δ {u}_{k + i} ‖}_{{R}_{du}}^{2}$$

is a term for reflecting the cost of the amount of change in a control value, and R_{du} represents a weight for the amount of change in the control value. The cost for the amount of change in the control value may be applied to limit excessive change in the control value in a target value following process.

Whereas the target value (r) may be optimized in the normal state, the control value may be optimized in a dynamic state where the state value (x) changes. That is, the optimal control value (u) may be derived from the dynamic state.

The optimal control value (u) derived as described above may correspond to a physical quantity that affects the vehicle thermal management depending on the operation of each component of the fluid transfer device 100, such as the mass flow of a refrigerant, a coolant, or air. In this case, the control unit 200 may convert the optimal control value (u) derived as such a physical quantity through the conversion process (the operation S320) to an operating quantity (u′), such as a rotational speed for controlling the operation of each component of the fluid transfer device 100 or a duty. However, the optimal control value (u) is not necessarily limited to the above description, and may have various forms depending on the respective components of the fluid transfer device 100. In this case, in a case where the conversion to the operating quantity is unnecessary, the conversion process (S320) may be omitted.

After the above optimization (S310) and conversion (S320) are performed, actual control for the components of the fluid transfer device 100 is executed according to the optimal control value (u) and the corresponding operating quantity (u′). Results of the control execution may be output in the form of the output value (y). In this case, the output value (y) may be collected through various sensors provided in the vehicle, converted into a physical quantity as necessary, and then transmitted to the control unit 200. In this case, the control unit 200 may determine the current state (x) and the disturbance (d) according to the output value (y), and the results may be reflected again in the optimization (S310).

Referring to FIG. 2, in performing the optimal control, the vehicle thermal management system according to the present embodiment changes a proportion of air conditioning target tracking performance and energy consumption for air conditioning target tracking reflected in an optimal control value according to an input optimal control setting value, thereby performing the optimal control in various ways.

More specifically, the vehicle thermal management system according to the present embodiment is provided with the fluid transfer device 100 that has a cooling or heating function for vehicle's interior air conditioning and consumes electric power to perform the cooling or heating function, and the control unit that controls the fluid transfer device 100 on the basis of an optimal control value obtained by reflecting the air conditioning target tracking performance and the energy consumption for the air conditioning target tracking. In particular, in one embodiment of the present disclosure, the proportion of the air conditioning target tracking performance and the energy consumption for the air conditioning target tracking reflected in the optimal control value may vary depending on the input optimal control setting value.

In this case, the optimal control setting value is a first setting value for increasing the proportion of the air conditioning target tracking performance reflected in the optimal control value, and a second setting for increasing the proportion of the energy consumption for the air conditioning target tracking reflected in the optimal control value. Additionally, the optimal control setting value may include a third setting value for balancing the proportion of the air conditioning target tracking performance reflected in the optimal control value and the proportion of the energy consumption for the air conditioning target tracking reflected in the optimal control value. In one embodiment, the first setting value, the second setting value, and the third setting value may be specific values, or may be specific value ranges.

The control unit 200 determines the control value for minimizing the cost function for the preset prediction range as the optimal control value. In this case, the cost function may reflect a state cost with a first weight for the air conditioning target tracking performance and a control input cost with a second weight for energy consumption for the air conditioning target tracking.

Here, the first weight and the second weight correspond to the proportion of the air conditioning target tracking performance reflected in the optimal value and the proportion of the air conditioning target tracking reflected in the optimal control value, respectively, and vary depending on the air conditioning setting values.

More specifically, the first weight and the second weight may vary according to the optimal control setting value. As the first weight increases, the proportion of the air conditioning target tracking performance reflected in the optimal control value may increase, and as the second weight increases, the proportion of the air conditioning target tracking reflected in the optimal control value may increase.

The above-mentioned cost function may be expressed, for example, as follows, and details related to the cost function have been described with reference to FIG. 3.

$$J ( {U}_{k} ) = {x}_{N}^{T} {Q}_{f} {x}_{N} + {\sum }_{i = 0}^{N - 1} ( {‖ {x}_{k + i} - {x}_{ss , k} ‖}_{Q}^{2} + {‖ {u}_{k + i} - {u}_{ss , k} ‖}_{R}^{2} + {‖ Δ {u}_{k + i} ‖}_{{R}_{du}}^{2} )$$

According to the above equation, Q may correspond to the first weight, and R may correspond to the second weight. The state cost and the control input cost are determined according to the first weight (Q) and the second weight (R). Accordingly, in a case where the first weight (Q) and the second weight (R) are changed according to the optimal control setting value, the proportion of the air conditioning target tracking performance reflected in the optimal control value and the proportion of the energy consumption for the air conditioning target tracking reflected in the optimal control value vary.

In addition, the control unit 200 may derive the optimal control value using a control model for the predictive state value according to the current state value. Here, the control model for the predictive state value described above with reference to FIG. 3 may be used as the control model for the predictive state value.

The control unit 200 may store the input optimal control setting values and may derive the optimal control value according to the stored optimal control setting values. For example, in a case where an optimal control setting value is input during vehicle driving, the control unit 200 may store the optimal control setting value and may use the value to derive an optimal control value in starting the vehicle next time.

The control unit 200 may control the fluid transfer device 100 in consideration of a preset optimal control mode. In this case, the optimal control mode may include a first optimal control mode and a second optimal control mode.

The first optimal control mode may be a mode for controlling an air conditioning target arrival time on the basis of the derived optimal control value while maintaining the air conditioning target. In one embodiment, the optimal control mode may be set as the first optimal control mode.

The second optimal control mode may be a mode for controlling the air conditioning target arrival time on the basis of the derived optimal control value and controlling the air conditioning target. In one embodiment, a separate control entry process may be necessary to perform the second air conditioning mode.

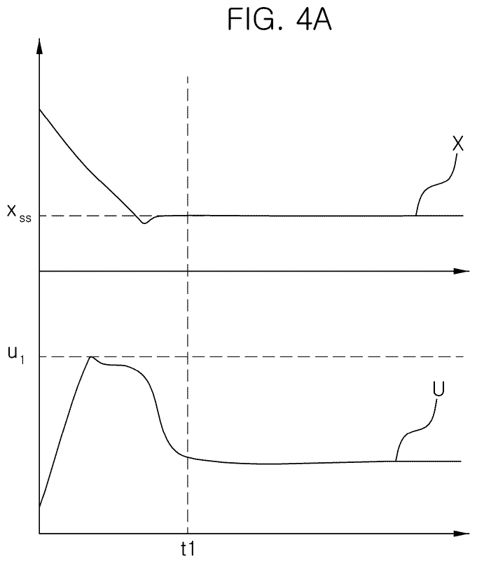

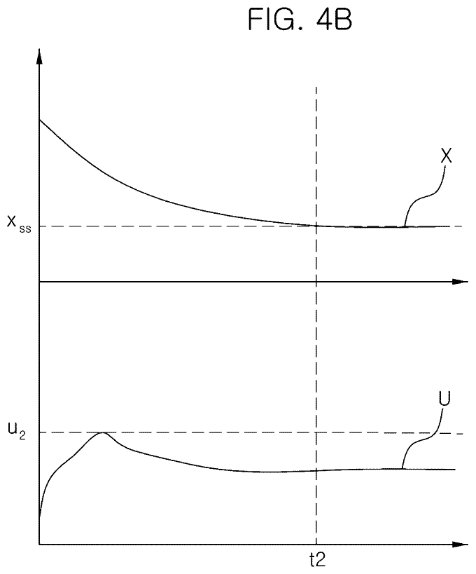

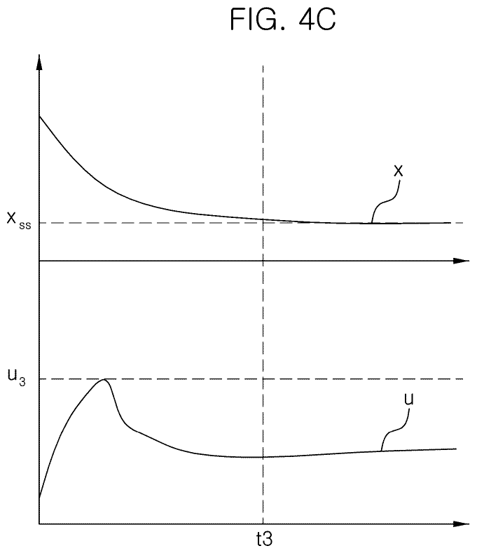

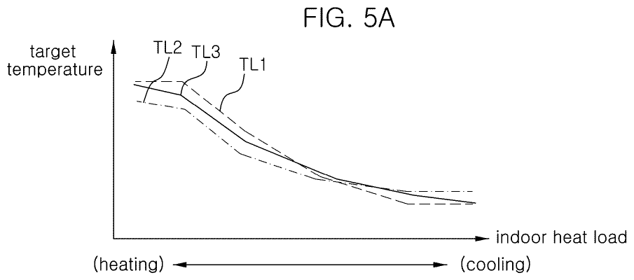

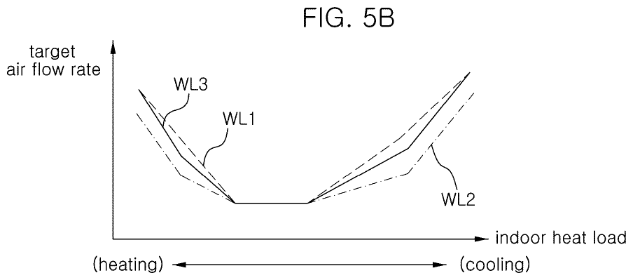

In this regard, detailed descriptions are given with reference to FIGS. 4A to 4C and FIGS. 5A and 5B.

FIGS. 4A to 4C are diagrams for illustrating optimal control according to air conditioning setting values according to an embodiment of the present disclosure.

FIGS. 4A to 4C are graphs showing processes of controlling the air conditioning target arrival time based on optimal control values in the first optimal control mode and the second optimal control mode, in which the horizontal axis represents time, and the vertical axis represents a state value and a control value.

More specifically, FIG. 4A shows a control process in a case where the optimal control setting value is a first setting value, FIG. 4B shows a control process in a case where the optimal control setting value is a second setting value, and FIG. 4C shows a control process in a case where the optimal control setting value is a third setting value.

In FIGS. 4A to 4C, it can be understood that state values (xₛₛ) corresponding to the air conditioning target are all the same, but air conditioning target arrival times (t1 to t3) and maximum control values (u1 to u3) in the air conditioning target tracking process may be different from each other. Here, the air conditioning target arrival times have the relationship t1<3<t2, and the maximum control values in the process of following the air conditioning target have the relationship u1<u3<u2.

In a case where the optimal control setting value is the first setting value for increasing the proportion of the air conditioning target tracking performance reflected in the optimal control value, the air conditioning target tracking performance is given priority, and thus, the state value (xₛₛ) corresponding to the air conditioning target is reached at the earliest time (t1), and the maximum control value in the air conditioning target tracking process has the largest value (u1).

In a case where the optimal control setting value is the second setting value for increasing the proportion of the energy consumption for the air conditioning target tracking reflected in the optimal control value, the energy consumption for the air conditioning target tracking is given priority, and thus, the state value (xₛₛ) corresponding to the air conditioning target is reached at the latest time (t2), and the maximum control value in the air conditioning target tracking process has the smallest value (u2).

In a case where the optimal control setting value is the third setting value for balancing the proportion of the air conditioning target tracking performance reflected in the optimal control value and the proportion of the energy consumption for the air conditioning target tracking reflected in the optimal control value, the state value (xₛₛ) corresponding to the air conditioning target is reached at the time (t3) slower than in the case of the first setting value and faster than in the case of the second setting value, and the maximum control value in the process of following the air conditioning target has the value (u3) smaller than in the case of the first setting value and larger than in the case of the second setting value.

The adjustment of the air conditioning target is described below.

FIGS. 5A and 5B are diagrams for illustrating an example of air conditioning target adjustment according to an embodiment of the present disclosure.

Referring to FIGS. 5A and 5B, graphs show the horizontal axis representing indoor heat load and the vertical axis representing an air conditioning target. As the indoor heat load becomes larger on the horizontal axis, the indoor air conditioning becomes closer to cooling, and as the indoor heat load becomes smaller on the horizontal axis, the indoor air conditioning becomes closer to heating.

In the second optimal control mode, the control unit 200 may adjust the air conditioning target on the basis of the optimal control setting value. For example, in the second air conditioning mode, the control unit 200 may change the air conditioning target in a case where the input optimal control setting value is the second setting value. In other words, in a setting state for increasing the energy consumption for the air conditioning target tracking, the control unit 200 not only controls the air conditioning target arrival time, but also adjusts the air conditioning target itself. In this case, the air conditioning target may be adjusted based on the optimal control setting value, a current air conditioning target, etc., and to this end, a preset lookup table may be utilized.

The air conditioning target may include a target temperature of vehicle's interior air, and in this case, the control unit 200 may change the air conditioning target in further consideration of whether the interior air conditioning is cooling or heating.

For example, in the second air conditioning mode, in a case where the input optimal control setting value is the second setting value and the interior air conditioning corresponds to cooling, the control unit 200 may increase the target temperature of the vehicle's interior air. In a state in which the second setting value is input, since the energy consumption for the air conditioning target tracking has priority to the air conditioning target tracking performance, the control unit 200 increases the target temperature during cooling, and accordingly, it becomes easier to achieve the air conditioning target, thereby making it possible to reduce energy consumption.

Conversely, in the second air conditioning mode, in a case where the input optimal control setting value is the second setting value and the interior air conditioning corresponds to heating, the control unit 200 may decrease the target temperature of the vehicle's interior air. In heating, the lower the target temperature, the easier it is to achieve the air conditioning target, which reduces energy consumption.

In this regard, referring to FIG. 5A, it can be understood that a target temperature (TL1) in a case where the optimal control setting value is the first setting value, a target temperature (TL2) in a case where the optimal control setting value is the second setting value, and a target temperature (TL3) in a case where the optimal control setting value is the third setting value are different from each other, under the same conditions. In the case of the first setting value (TL1) and the third setting value (TL3), the target temperatures on the cooling and heating sides are substantially the same, but in the case of the second setting value (TL2), the target temperature in cooling becomes higher and the target temperature in heating becomes lower according to the air conditioning target adjustment.

In addition, the air conditioning target may include a target flow rate of air discharged into the vehicle's cabin. In this case, in a case where the input optimal control setting value in the second air conditioning mode is the second setting value, the control unit 200 decreases the target flow rate of air discharged into the vehicle's cabin to save energy.

In this regard, referring to FIG. 5B, it can be understood that a target flow rate (WL1) in a case where the optimal control setting value is the first setting value, a target flow rate (WL2) in a case where the optimal control setting value is the second setting value, and a target flow rate (WL3) in a case where the optimal control setting value is the third setting value are different from each other, under the same conditions. In the case of the first setting value (WL1) and the third setting value (WL3), the target flow rates in cooling and heating are substantially the same, but in the case of the second setting value (WL2), the target flow rates in cooling and heating become lower according to the air conditioning target adjustment.

Further, in the second air conditioning mode, the control unit 200 may change the air conditioning target in further consideration of upper and lower limits of the preset air conditioning target. For example, during cooling, the target temperature may be controlled so as not to exceed the preset upper limit temperature, and during heating, the target temperature may be controlled so as not to be lower than the preset lower limit temperature. Thus, while taking the energy consumption for the air conditioning target tracking into account, it is possible to basically secure thermal comfort.

After the air conditioning target is changed in the second optimal control mode, the control unit 200 maintains the changed air conditioning target as in the first optimal control mode, and adjusts the air conditioning target arrival time on the basis of the optimal control value.

In addition, in a case where the input optimal control setting value is the first setting value, the control unit 200 may maintain the air conditioning target, unlike the case where the optimal control setting value is the second setting value. In this case, the thermal comfort is more important in control.

Meanwhile, the optimal control setting value may be set by a vehicle user such as a driver, and thus, the user's intention or preference for interior thermal comfort and energy saving may be reflected in the optimal control for air conditioning performance. For example, in a case where the user inputs the first setting value as the optimal control setting value, since the air conditioning target tracking performance is given priority in deriving the optimal control value, it is possible to achieve the air conditioning target faster, thereby improving thermal comfort. In a case where the user inputs the second setting value as the optimal control setting value, since the energy consumption for the air conditioning target tracking is given priority, it is possible to reduce power consumption for the air conditioning target arrival, thereby improving the energy efficiency of thermal management.

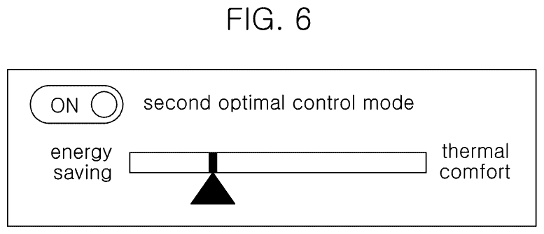

To this end, the interface unit 300 may receive the optimal control setting value from the user, and transmit the received optimal control setting value to the control unit 200. The interface unit 300 will be described with reference to FIG. 6.

FIG. 6 is a diagram showing an example of implementation of an interface unit according to an embodiment of the present disclosure.

Referring to FIG. 6, the interface unit 300 may receive input of an optimal control setting value and an optimal control mode from a user through a screen, and may visually display a current setting state.

In a case where the user prioritizes interior thermal comfort, the user may operate the interface for thermal comfort. In this case, the optimal control setting value may be the first setting value. Conversely, in a case where the user prioritizes energy saving in the air conditioning process, the user may operate the interface for energy saving. In this case, the optimal control setting value may be the second setting value. Further, the optimal control setting value may have a value between the first setting value and the second setting value, such as the third setting value, and the value may be determined by operating the interface.

In addition, the setting of the optimal control mode may be performed using a toggle button that determines on/off of the second optimal control mode. In this case, the user may select the first optimal control mode by turning off the second optimal control mode.

Hereinafter, the above-described vehicle thermal management process is described with reference to a flowchart.

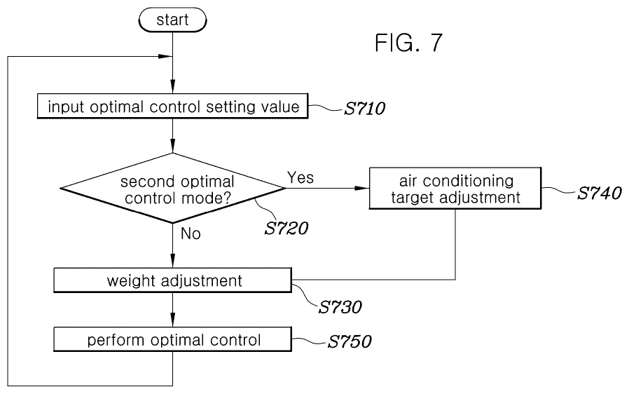

FIG. 7 is a flowchart for illustrating a process of performing vehicle thermal management according to an embodiment of the present disclosure.

Referring to FIG. 7, the control unit 200 may receive an optimal control setting value and an optimal control mode from a user through the interface unit 300 (an operation S710).

In a case where the input optimal control mode is not the second optimal control mode (No in an operation S720), the control unit 200 may adjust a state cost having a first weight for air conditioning target tracking performance and a control input cost having a second weight for energy consumption for air conditioning target tracking based on the optimal control setting value without adjustment of an air conditioning target (an operation S730).

In a case where the input optimal control mode is the second optimal control mode (Yes in the operation S720), after adjusting the air conditioning target (an operation S740), the control unit 200 may perform weight adjustment according to the optimal control setting value (the operation S730).

Then, the control unit 200 derives the optimal control value in consideration of the weight adjusted according to the optimal control setting value, and performs optimal control on the basis of the result (an operation S750).

According to the embodiments of the present disclosure, by performing optimal control for vehicle thermal management, it is possible to energy-efficiently perform the vehicle thermal management, thereby increasing the fuel efficiency of a vehicle and a distance to empty compared to a state of charge.

In addition, by performing optimal control for the vehicle thermal management in consideration of user's setting, it is possible to satisfy various user demands, thereby improving vehicle marketability.

The effects that can be obtained from the present disclosure are not limited to the effects mentioned above, and other effects not mentioned should be clearly understood by those having ordinary skill in the art from the description.

Although the some embodiments of the present disclosure have been disclosed for illustrative purposes, those having ordinary skill in the art would appreciate that various modifications, additions and substitutions are possible, without departing from the scope and spirit of the disclosure as disclosed in the accompanying claims.

What is claimed is:

1. A vehicle thermal management system comprising:
a fluid transfer device configured to perform a cooling or heating function for interior air conditioning of a vehicle with electric power; and
a control unit configured to control the fluid transfer device based on an optimal control value obtained by reflecting air conditioning target tracking performance and energy consumption for air conditioning target tracking,
wherein proportions of the air conditioning target tracking performance and the energy consumption for the air conditioning target tracking reflected in the optimal control value vary based on an input optimal control setting value.

2. The vehicle thermal management system of claim 1, wherein the optimal control setting value includes:
a first setting value that increases the proportion of the air conditioning target tracking performance reflected in the optimal control value, and
a second setting value that increases the proportion of the energy consumption for the air conditioning target tracking reflected in the optimal control value.

3. The vehicle thermal management system of claim 2, wherein the optimal control setting value includes a third setting value that balances the proportion of the air conditioning target tracking performance reflected in the optimal control value and the proportion of the energy consumption for the air conditioning target tracking reflected in the optimal control value.

4. The vehicle thermal management system of claim 2, wherein the control unit is configured to control the fluid transfer device based on a preset optimal control mode, and the preset optimal control mode includes a first optimal control mode that controls an air conditioning target arrival time based on the optimal control value while maintaining an air conditioning target.

5. The vehicle thermal management system of claim 2, wherein the control unit is configured to control the fluid transfer device based on a preset optimal control mode, and the preset optimal control mode includes a second optimal control mode that controls an air conditioning target arrival time based on the optimal control value and adjusts an air conditioning target.

6. The vehicle thermal management system of claim 5, wherein the control unit is configured to adjust the air conditioning target based on the optimal control setting value in the second optimal control mode.

7. The vehicle thermal management system of claim 6, wherein the control unit is configured to change the air conditioning target when the input optimal control setting value is the second setting value, in the second optimal control mode.

8. The vehicle thermal management system of claim 6, wherein the air conditioning target includes a target temperature of interior air of the vehicle.

9. The system of claim 8, wherein the control unit is configured to change the air conditioning target based on whether the interior air conditioning is cooling or heating, in the second optimal control mode.

10. The vehicle thermal management system of claim 9, wherein the control unit is configured to increase the target temperature of the interior air when the input optimal control setting value is the second setting value and the interior air conditioning is the cooling, in the second optimal control mode.

11. The vehicle thermal management system of claim 9, wherein the control unit is configured to decrease the target temperature of the interior air when the input optimal control setting value is the second setting value and the interior air conditioning is the heating, in the second optimal control mode.

12. The vehicle thermal management system of claim 7, wherein the air conditioning target includes a target flow rate of air discharged into a cabin of the vehicle.

13. The vehicle thermal management system of claim 12, wherein the control unit is configured to decrease the target flow rate of air discharged into the cabin when the input optimal control setting value is the second setting value, in the second optimal control mode.

14. The vehicle thermal management system of claim 7, wherein the control unit is configured to change the air conditioning target based on upper and lower limits of the air conditioning target.

15. The vehicle thermal management system of claim 6, wherein the control unit is configured to maintain the air conditioning target when the input optimal control setting value is the first setting value, in the second optimal control mode.

16. The vehicle thermal management system of claim 1, wherein the control unit is configured to determine a control value that minimizes a cost function for a preset prediction range as the optimal control value, and the cost function reflects a state cost having a first weight for the air conditioning target tracking performance and a control input cost having a second weight for the energy consumption for the air conditioning target tracking.

17. The vehicle thermal management system of claim 16, wherein the first weight and the second weight vary based on the optimal control setting value, and
as the first weight increases, the proportion of the air conditioning target tracking performance reflected in the optimal control value increases, and as the second weight increases, the proportion of the air conditioning target tracking reflected in the optimal control value increases.

18. The vehicle thermal management system of claim 1, wherein the control unit is configured to derive the optimal control value using a control model for a predictive state value according to a current state value.

19. The vehicle thermal management system according to claim 1, wherein the control unit is configured to store the optimal control setting value and derive the optimal control value based on the stored optimal control setting value.

20. The vehicle thermal management system of claim 1, further comprising:
an interface unit configured to receive the optimal control setting value from a user, and to transmit the received optimal control setting value to the control unit.
